(19) United States
(12) Patent Application Publication
(10) Pub. No.: US 2006/0286312 A1
(43) Pub. Date: Dec. 21, 2006

(54) Apparatus for fabricating a display panel and method of doing the same

(75) Inventor: Toshihiko Motomatsu, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC LCD TECHNOLOGIES, LTD., Kawasaki-shi (JP)

(21) Appl. No.: 11/447,976

(22) Filed: Jun. 7, 2006

(30) Foreign Application Priority Data
Jun. 15, 2005 (JP) 2005-174977

(51) Int. Cl. C09K 19/00

(52) U.S. Cl. 428/1.26

(57) ABSTRACT

An apparatus for fabricating a display panel including a pair of substrates facing each other, includes units for carrying out steps for fabricating the display panel, the steps being to be carried out before the substrates are adhered to each other, a substrate carrier for carrying the substrates, a buffer for storing the substrates therein, and a unit for substituting inert gas for internal gas and/or a chemical filter unit, arranged in at least one of each of the units, the substrate carrier and the buffer.

### BACKGROUND OF THE INVENTION

1. Field of the Invention

The invention relates to an apparatus and a method for fabricating a display panel such as a liquid crystal display panel.

2. Description of the Related Art

A liquid crystal display device is presently broadly used as a display device for AV or OA devices because it is thin, light and consumes low power.

A liquid crystal display device is comprised of, for instance, a liquid crystal panel, and a back-light unit for illuminating the liquid crystal panel. The liquid crystal panel is comprised of a first substrate (hereinafter, called “array substrate”) on which switching devices such as thin film transistors (TFTs) are arranged in a matrix, a second substrate (hereinafter, called “CF substrate”) on which a color filter (CF) and a black matrix (BM) are arranged, and a liquid crystal layer sandwiched between the array and CF substrates. A direction in which liquid crystal molecules are oriented is controlled by an electric field generated by electrodes arranged on at least one of array and CF substrates, thereby varying transmittance of back-light emitted from the back-light unit, to display desired images.

A method of fabricating a liquid crystal display panel includes the steps of coating polyimide onto surfaces of the array and CF substrates by means of a printer, baking the polyimide to thereby form an alignment film, rubbing the alignment film at a surface thereof with a buff cloth wound around a rotary metal roller, removing residue of the rubbing such as fiber residue of the buff cloth and scraped residue of the alignment film, drawing sealing material and further coating silver on one of the substrates by means of a dispenser, distributing spacers such as polymer beads or silica beads onto the other substrate, dropping liquid crystal onto the substrate on which the sealing material was drawn, adhering the array and CF substrates to each other, and pressuring the substrates to curing the sealing material.

FIG. 1 illustrates a conventional ODF (One-Drop Fill) line.

The illustrated ODF line includes a unit 100 for rubbing array and CF substrates, a unit 110 for removing residues by cleaning and drying array and CF substrates, units 120 for carrying out the above-mentioned steps except the rubbing step and residue-removing step, a substrate carrier 130 for carrying an array or CF substrate into a certain unit from another unit, and a substrate buffer 140 for storing an array or CF substrate which is to be carried into a certain unit.

In a process of fabricating a liquid crystal display panel, it is important to remove contaminants out of fabrication-process atmosphere in order to enhance quality of a liquid crystal display panel and a yield of fabrication of a liquid crystal display panel.

For instance, units for carrying out steps to be carried out after a rubbing step and a residue-removing step, a substrate carrier, and a substrate buffer are equipped with a high efficiency particular air (HEPA) filter in order to remove contaminants in fabrication-process atmosphere. As an alternative, some units are filled with inert gas.

For instance, Japanese Patent Application Publication No. 2001-242471 has suggested an apparatus for adhering a pair of substrates to each other, including a chamber filled with inert gas.

The conventional ODF line illustrated in FIG. 1 is accompanied with a problem of internal defectiveness of a liquid crystal display panel, such as spots, non-uniformity and bubbles, caused by contamination of surfaces of the substrates. In particular, a number of such defectiveness increases during the substrates are stocked before any step is carried out to the substrates.

Hereinbelow the problem is explained in detail with reference to FIGS. 2 to 5.

FIG. 2 is a graph showing a relation between a bubble generating rate and a time during which any step is not carried out to a substrate.

It is understood in view of FIG. 2 that as a time during which any step is not carried out to a substrate is longer, that is, as a time during which a substrate is exposed to impurities is longer, more bubbles are generated in a liquid crystal panel when array and CF substrates are adhered to each other.

FIG. 3 is a graph showing a relation between a contact angle measured at a surface of a substrate and a time during which any step is not carried out to a substrate.

It is understood in view of FIG. 3 that as a time during which any step is not carried out to a substrate is longer, a contact angle of liquid crystal drop at a surface of a substrate becomes greater, resulting in that hydrophilicity of a substrate is reduced and hence wettability of a substrate is deteriorated.

FIG. 4 is a graph showing a relation between a volume of cation existing at a surface of a substrate and a time during which any step is not carried out to a substrate, and FIG. 5 is a graph showing a relation between a volume of anion existing at a surface of a substrate and a time during which any step is not carried out to a substrate.

It is understood in view of FIGS. 4 and 5 that as a time during which any step is not carried out to a substrate is longer, cation and anion exist in a higher volume.

As mentioned before, in order to overcome the above-mentioned problem, the conventional ODF line is equipped with a HEPA filter in the units, the substrate carrier or the substrate buffer, or some units are filled with inert gas.

However, even if a HEPA filter is equipped in an ODF line, it is not possible to completely remove contaminants for keeping a surface of a substrate clean.

Furthermore, if some units are filled with inert gas, it would be possible to avoid contamination of a substrate in the units. However, it is not possible to avoid a substrate from being contaminated in the rest of the units.

### SUMMARY OF THE INVENTION

In view of the above-mentioned problem in the prior art, it is an object of the present invention to provide an apparatus for fabricating a display panel which is capable of completely removing contaminants in fabrication process to thereby suppress defectiveness in displaying image, and enhance quality in displaying images and a yield in fabrication of a display panel.

It is also an object of the present invention to provide a method of fabricating a display panel which is capable of doing the same.

In one aspect of the present invention, there is provided an apparatus for fabricating a display panel including a pair of substrates facing each other, including units for carrying out steps for fabricating the display panel, the steps being to be carried out before the substrates are adhered to each other, a substrate carrier for carrying the substrates, a buffer for storing the substrates therein, and at least one of a unit for substituting inert gas for internal gas, and a chemical filter unit, arranged in at least one of each of the units, the substrate carrier and the buffer.

For instance, the unit for substituting inert gas for internal gas is comprised of a unit for substituting nitrogen gas for internal gas.

It is preferable that the unit for substituting inert gas for internal gas maintains an oxygen concentration in the units, the substrate carrier and the buffer to be equal to or smaller than about 20%.

For instance, the display panel is comprised of a liquid crystal display panel.

It is preferable that the chemical filter unit removes organic materials which increase a contact angle of liquid crystal drops at surfaces of the substrates.

In another aspect of the present invention, there is provided a method of fabricating a display panel including a pair of substrates facing each other, including (a) disposing at least one of a unit for substituting inert gas for internal gas s and a chemical filter unit in areas where steps for fabricating the display panel are carried out before the substrates are adhered to each other, and (b) measuring one of a contact angle of liquid crystal drops at surfaces of the substrates and a concentration of impurities residual at surfaces of the substrates to know cleanness of the surfaces of the substrates, based on the measured contact angle or concentration of impurities.

The method may further include the steps of (c) rubbing the substrates, (d) dropping liquid crystal onto one of the substrates, and (e) adhering the substrates to each other with sealing material being sandwiched therebetween. The step (a) is carried out before and during the steps (c) and (d), and the step (b) is carried out prior to the step (e).

For instance, the inert gas is comprised of nitrogen gas.

It is preferable that the unit for substituting inert gas for internal gas maintains an oxygen concentration in the areas to be equal to or smaller than about 20%.

It is preferable that the chemical filter unit removes organic materials which increase a contact angle of liquid crystal drops at surfaces of the substrates.

It is preferable that the contact angle is measured immediately before the substrates are adhered to each other.

It is preferable that subsequent steps are carried out when the contact angle is equal to or smaller than about 13 degrees.

It is preferable that the concentration of impurities is measured after the sealing material is drawn onto one of the substrates and further after spacers are distributed onto the other.

It is preferable that subsequent steps are carried out when a total volume of cation and anion both existing at surfaces of the substrates is equal to or smaller than 1 ng/cm².

It is preferable that subsequent steps are carried out when a total volume of organic material existing at surfaces of the substrates is equal to or smaller than 0.1 ng/cm².

For instance, the display panel is comprised of a liquid crystal display panel.

The advantages obtained by the aforementioned present invention will be described hereinbelow.

In accordance with the present invention, the unit for purging inert gas or the chemical filter unit completely removes contaminants existing in fabrication-process atmosphere, avoiding defectiveness in displaying images and enhancing both quality in displaying images and a fabrication yield.

Specifically, the apparatus and method in accordance with the present invention removes contaminants existing in ODF line, and reduces internal defectiveness of a liquid crystal display panel, such as spots, non-uniformity and bubbles, caused by contamination of surfaces of the substrates. As a result, the apparatus and method in accordance with the present invention ensures a liquid crystal panel providing high quality in displaying images and having a high fabrication yield.

This is because the unit for purging inert gas and/or the chemical filter unit are(is) equipped in at least one of each of units for carrying out steps to be carried out in an ODF line after both a step of rubbing substrates and a step of removing impurities out of substrates (or cleaning and drying substrates), a substrate carrier, and a substrate buffer, to thereby keep high cleanness at surfaces of substrates. Furthermore, a contact angle of liquid crystal at surfaces of substrates and a concentration of impurities are measured so as to check cleanness of surfaces of substrates, based on the measured contact angle and concentration.

In a process of fabricating a liquid crystal display panel, it is important to remove contaminants out of fabrication-process atmosphere in order to enhance quality of a liquid crystal display panel and a yield of fabrication of a liquid crystal display panel. To this end, units for carrying out steps in an ODF line, a substrate carrier, and a substrate buffer were conventionally equipped with a high efficiency particular air (HEPA) filter in order to remove contaminants in fabrication-process atmosphere. As an alternative, some units were filled with inert gas. However, the HEPA filter could not completely contaminants existing in an ODA line. Even if some units were filled with inert gas, it would not be possible to avoid a substrate from being contaminated in other units and/or a substrate carrier.

In order to avoid the above-mentioned problems, a unit for enhancing cleanness may be equipped in an ODF line. However, such a unit would be accompanied with another problem of high costs, resulting in an increase in a price of a final product, that is, a liquid crystal display panel.

In view of the problems, the inventor found the invention to effectively keep a substrate clean, based on the result of the experiment showing that as a time for not applying any step to a substrate was longer, a contact angle of liquid crystal at a surface of a substrate became greater and a concentration of impurities existing at a surface of a substrate became higher.

Specifically, the unit for purging inert gas and/or the chemical filter unit are(is) equipped in at least one of each of units for carrying out steps to be carried out in an ODF line after both a step of rubbing substrates and a step of removing impurities out of substrates (or cleaning and drying substrates), a substrate carrier, and a substrate buffer, to thereby keep high cleanness at surfaces of substrates. Furthermore, a contact angle of liquid crystal at surfaces of substrates and a concentration of impurities are measured so as to check cleanness of surfaces of substrates, based on the measured contact angle and concentration. This ensures removal of contaminants existing in an ODF line and a high fabrication yield of a liquid crystal display panel providing high quality of displaying images.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 illustrates a conventional ODF (One-Drop Fill) line.

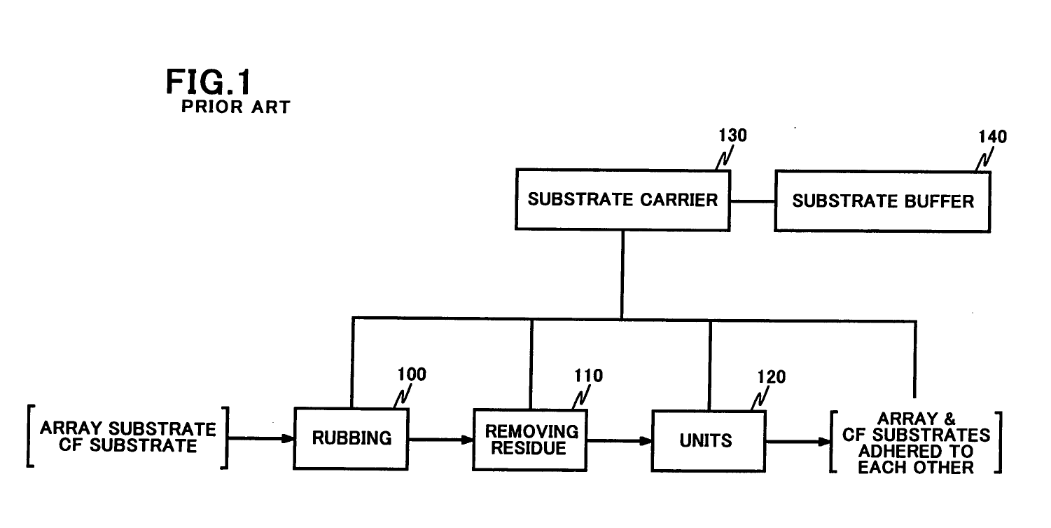

FIG. 2 is a graph showing a relation between a bubble generating rate and a time during which any step is not carried out to a substrate.

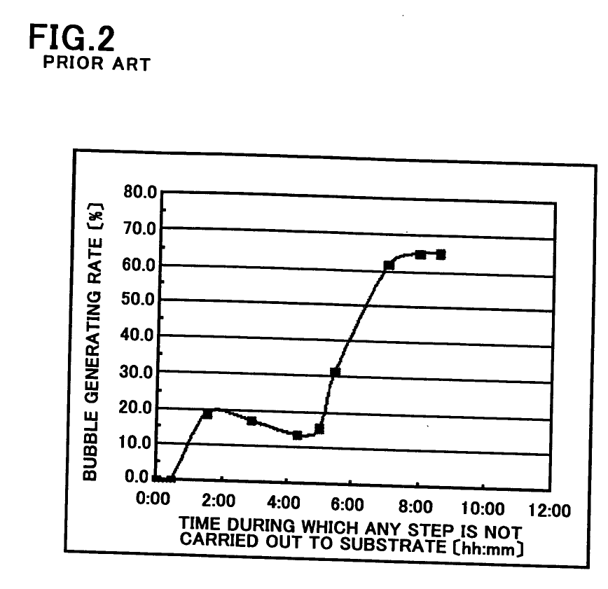

FIG. 3 is a graph showing a relation between a contact angle measured at a surface of a substrate and a time during which any step is not carried out to a substrate.

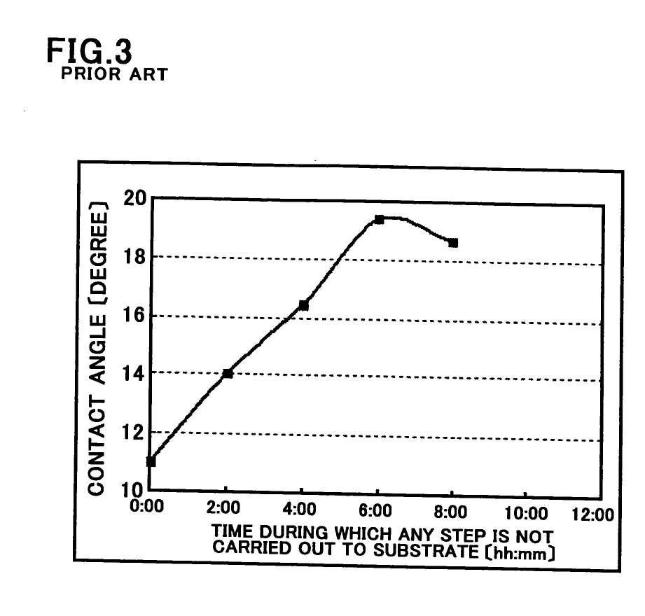

FIG. 4 is a graph showing a relation between a volume of cation existing at a surface of a substrate and a time during which any step is not carried out to a substrate.

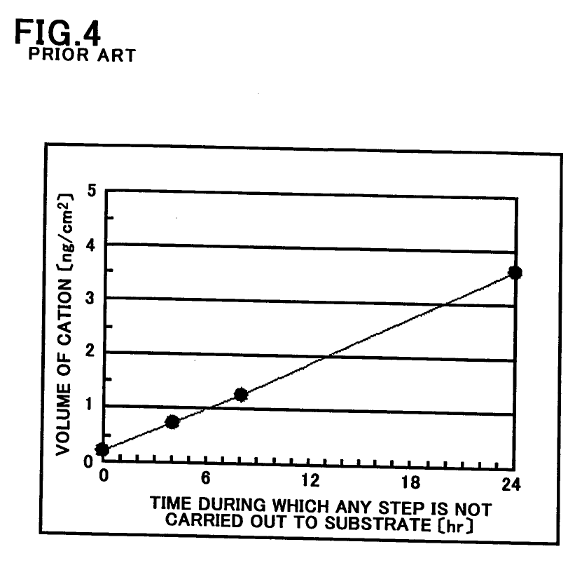

FIG. 5 is a graph showing a relation between a volume of anion existing at a surface of a substrate and a time during which any step is not carried out to a substrate.

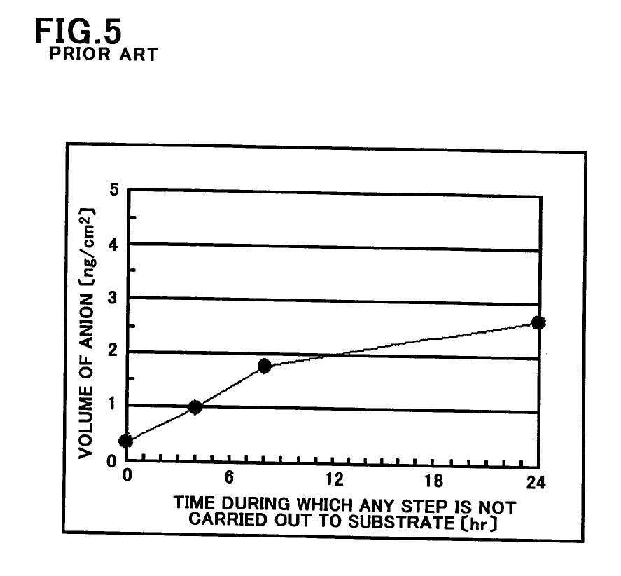

FIG. 6 illustrates an ODF line for fabricating a liquid crystal display panel in accordance with the first embodiment of the present invention.

FIG. 7 is a cross-sectional view of the dispenser unit equipped therein with the unit for substituting clean nitrogen gas for internal air of the dispenser unit.

FIG. 8 is a cross-sectional view of the substrate buffer including a substrate cassette in which substrates are stored.

FIG. 9 is a graph showing a volume of inorganic ions measured during a step of dropping liquid crystal onto a substrate and a step of adhering the substrates to each other, both before the unit for substituting clean nitrogen gas for internal air is disposed in the substrate carrier and after the unit has been disposed in the substrate carrier.

FIG. 10 is a graph showing a volume of organic material measured during a step of dropping liquid crystal onto a substrate and a step of adhering the substrates to each other, both before the unit for substituting clean nitrogen gas for internal air is disposed in the substrate carrier and after the unit has been disposed in the substrate carrier.

FIG. 11 illustrates an ODF line for fabricating a liquid crystal display panel in accordance with a variant of the first embodiment of the present invention.

### DESCRIPTION OF THE PREFERRED EMBODIMENTS

Preferred embodiments in accordance with the present invention will be explained hereinbelow with reference to drawings.

### First Embodiment

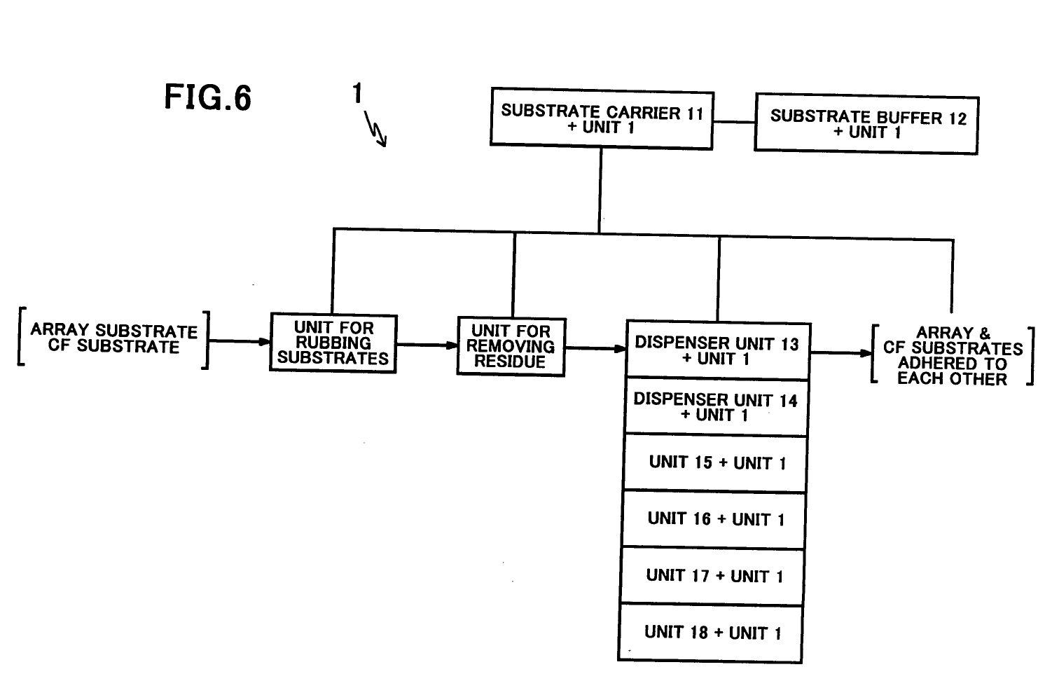

An apparatus and a method for fabricating a liquid crystal display panel in accordance with the first embodiment of the present invention is explained hereinbelow with reference to FIGS. 6 to 11.

FIG. 6 illustrates an ODF line for fabricating a liquid crystal display panel in accordance with the first embodiment of the present invention.

A liquid crystal display device is comprised generally of a liquid crystal panel, and a back-light unit for illuminating the liquid crystal panel. The liquid crystal panel is comprised of an array substrate on which switching devices such as thin film transistors (TFTs) are arranged in a matrix, a CF substrate on which a color filter (CF) and a black matrix (BM) are arranged, and a liquid crystal layer arranged in a gap formed between the array and CF substrates by arranging electrically insulating spacers such as polymer beads and silica beads between the array and CF substrates. The array and CF substrates have a rubbed alignment film on surfaces thereof facing each other.

A direction in which liquid crystal molecules are oriented is controlled by an electric field generated by electrodes arranged on at least one of array and CF substrates, thereby varying transmittance of back-light emitted from the back-light unit, to display desired images.

Thus, it is necessary to prevent contaminants from entering a gap formed between the array and CF substrates in order to enhance display quality and a fabrication yield of a liquid crystal display panel. However, if the substrates could not be effectively cleaned, there is caused a problem that a liquid crystal display panel would be expensive.

In accordance with the first embodiment of the present invention, a unit 1 for substituting clean nitrogen gas for internal air is equipped in units comprising an ODF line, a substrate carrier and/or a substrate buffer, when array and CF substrates having been already rubbed, cleaned and dried are put into an ODF line.

Specifically, as illustrated in FIG. 6, the unit 1 for substituting clean nitrogen gas for internal air is equipped in at least one of each of units for carrying out a step in a fabrication process, a substrate carrier 11, and a substrate buffer 12.

The units for carrying out a step in a fabrication process includes, for instance, a dispenser unit 13 for drawing sealing material and further coating silver on one of array and CF substrates, a dispenser unit 14 for dropping liquid crystal onto one of array and CF substrates, a unit 15 for distributing spacers onto one of the array and CF substrates, a unit 16 for fixing spacers onto the array and CF substrates, a unit 17 for adhering the array and CF substrates to each other, and a unit 18 for pressuring the substrates to curing the sealing material.

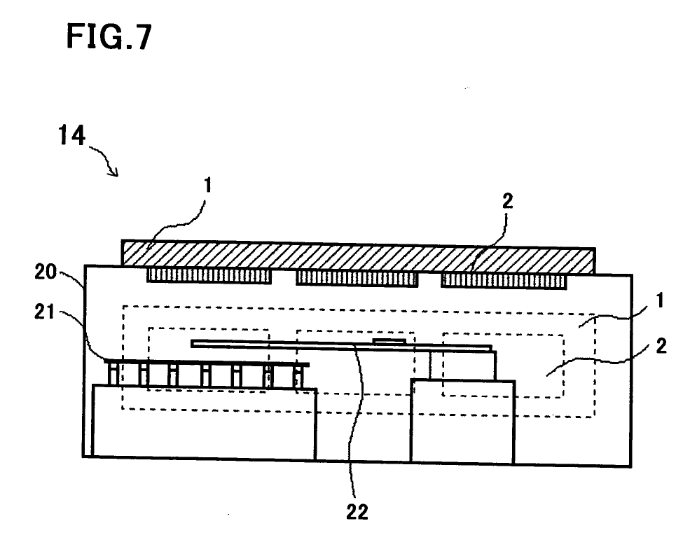

FIG. 7 is a cross-sectional view of the dispenser unit 14 equipped therein with the unit 1 for substituting clean nitrogen gas for internal air of the dispenser unit 14.

The dispenser unit 14 has a closed chamber 20 in which a substrate 21 is horizontally placed. The substrate carrier 11 includes a robot arm 22 for carrying the substrate 21 from a first position to a second position.

As illustrated in FIG. 7, the unit 1 is arranged at a ceiling and/or sidewalls of the chamber 20. If possible, the unit 1 may be arranged at a bottom of the chamber 20.

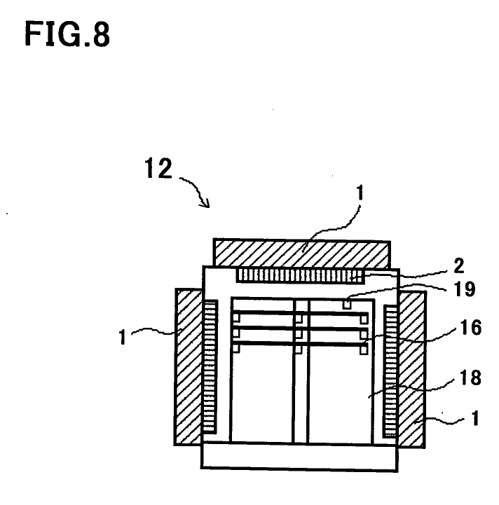

FIG. 8 is a cross-sectional view of the substrate buffer 12 including a substrate cassette 18 in which the substrates 21 are stored.

As illustrated in FIG. 8, the unit 1 is arranged at a ceiling and/or sidewalls of the substrate buffer 12.

If it is not possible to arrange the unit 1 at a ceiling and/or sidewalls, the unit 1 may be arranged at an inlet of a unit through which the substrate 21 are introduced therein and taken away out thereof.

The unit 1 may be equipped singly or in plural in each of the above-mentioned units, the substrate carrier 11 and/or the substrate buffer 12.

Though the unit 1 uses nitrogen gas in the first embodiment, the unit 1 may be designed to use inert gas except nitrogen gas.

The inventor conducted the experiments and found that it would be possible to prevent contaminants from entering a unit, if a concentration of oxygen in the unit is kept equal to or smaller than about 20%.

Accordingly, as illustrated in FIG. 8, it is preferable that an oxygen concentration meter 19 is arranged together with the unit 1 in the above-mentioned units, the substrate carrier 11 and/or the substrate buffer 12. A concentration of oxygen measured by the oxygen concentration meter 19 is transmitted to the unit 1, and the unit 1 controls an oxygen concentration such that an oxygen concentration in a unit is kept equal to or smaller than about 20%.

In accordance with the above-mentioned first embodiment, the unit 1 equipped in each of the units in an ODF line, the substrate carrier 11 and/or the substrate buffer 12 reduces spots and/or non-uniformity occurring in a liquid crystal display panel.

Furthermore, the unit 1 further reduces bubbles to be generated in a panel for the reason of contamination at surfaces of the array and CF substrates, when the array and CF substrates are adhered to each other.

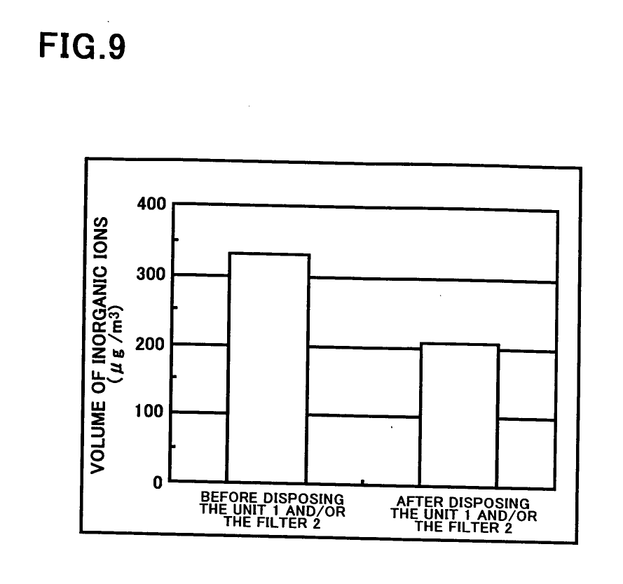

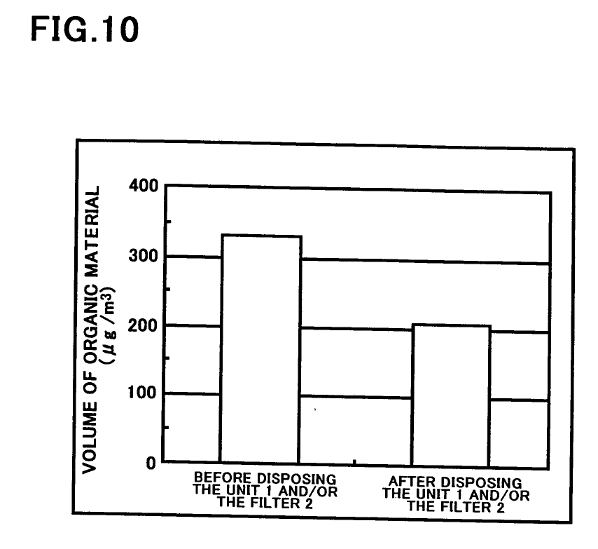

Hereinbelow is explained the performances of the unit 1 and the chemical filter unit 2 with reference to FIGS. 9 and 10.

FIG. 9 is a graph showing a volume of inorganic ions measured during a step of dropping liquid crystal onto a substrate and a step of adhering the substrates to each other, both before the unit 1 is disposed in the substrate carrier 11 and after the unit 1 has been disposed in the substrate carrier 11, and FIG. 10 is a graph showing a volume of organic material measured during a step of dropping liquid crystal onto a substrate and a step of adhering the substrates to each other, both before the unit 1 is disposed in the substrate carrier 11 and after the unit 1 has been disposed in the substrate carrier 11.

In FIGS. 9 and 10, inorganic ions and organic material were measured by the TENAX absorption tube capture process. After inorganic ions have been measured, cation contained in the inorganic ions was measured by means of an atomic absorption photometer, and anion contained in the inorganic ions was measured by ion-chromatography. The organic material was measured by Gas Chromatography to Mass Spectrometry (GC-MS).

As is obvious in view of FIGS. 9 and 10, inorganic ions and organic material are reduced in a fabrication process by virtue of the unit 1.

In the first embodiment, a contact angle of liquid crystal or a concentration of impurities is measured during a process of fabricating a liquid crystal display panel. It is checked whether a surface of each of the array and CF substrates is kept clean, based on the measured contact angle or impurities concentration. Subsequent steps are carried out or not in dependence on the result of checking.

It is preferable that a contact angle is measured before the array and CF substrates are adhered to each other.

The smaller contact angle (contact angle measured in a predetermined lead time) indicates higher cleanness at a surface of each of the array and CF substrates.

According to the discovery of the inventor, if a contact angle of liquid crystal were equal to or smaller than about 13 degrees, it would be possible to suppress spots, non-uniformity and bubbles generated in a liquid crystal display panel, down to a non-problem level.

It is preferable that a concentration of impurities at a surface of the array substrate is measured after spacers have been distributed and fixed onto the substrate, and that a concentration of impurities at a surface of the CF substrate is measured after sealing material has been drawn onto the substrate and silver has been coated onto the substrate.

The smaller concentration of impurities indicates higher cleanness at a surface of each of the array and CF substrates.

According to the discovery of the inventor, if a total volume of inorganic ions (cation and anion) is equal to or smaller than about 1 ng/cm² or a volume of organic material is equal to or smaller than about 0.1 ng/cm², it would be possible to suppress spots, non-uniformity and bubbles generated in a liquid crystal display panel, down to a non-problem level.

As mentioned above, surfaces of the array and CF substrates can be kept clean by arranging the unit 1 in at least one of each of the units comprising an ODF line, the substrate carrier 11 and the substrate buffer 12, and keeping an oxygen concentration in each of the units, the substrate carrier 11 and the substrate buffer 12 to be equal to or smaller than about 20%.

Furthermore, it is possible to judge a surface of the array and CF substrates to be clean, if a contact angle of liquid crystal is equal to or smaller than about 13 degrees, if a total volume of inorganic ions (cation and anion) is equal to or smaller than about 1 ng/cm², or if a volume of organic material is equal to or smaller than about 0.1 ng/cm², making it possible to suppress spots, non-uniformity and bubbles generated in a liquid crystal display panel, down to a non-problem level.

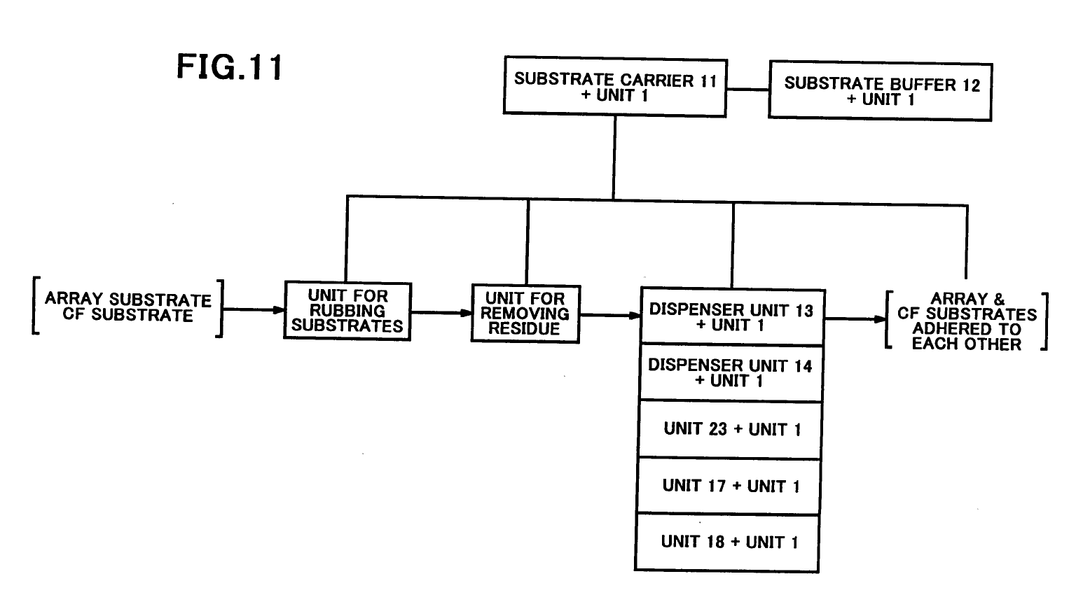

In the first embodiment, the unit 15 is used for distributing spacers onto one of the array and CF substrates to form a gap between the array and CF substrates. In place of using spacers, there may be used a CF substrate including pillars perpendicularly outwardly extending therefrom, in which case, as illustrated in FIG. 11, a unit 23 of measuring pillars of the CF substrate is used in place of the unit 15 for distributing spacers onto one of the array and CF substrates and the unit 16 for fixing spacers onto the array and CF substrates.

### Second Embodiment

In the above-mentioned first embodiment, the unit 1 for substituting clean nitrogen gas for internal air is used. As illustrated in FIG. 7, a chemical filter unit 2 may be used in place of the unit 1.

The chemical filter unit 2 has a function of chemically, removing particular contaminants.

The chemical filter unit 2 can remove various contaminants. In particular, the chemical filter unit 2 can effectively reduce organic material which increases a contact angle, such as siloxane and phthalate ester.

Similarly to the unit 1, the chemical filter unit 2 prevents contaminants from sticking to a surface of the array and CF substrates, and reduces generation of spots, non-uniformity and bubbles in a liquid crystal display panel.

### Third Embodiment

The unit 1 for substituting clean nitrogen gas for internal air is used in the above-mentioned first embodiment, and in the chemical filter unit 2 is used in the second embodiment.

In the third embodiment, both the unit 1 and the chemical filter unit 2 are arranged in each of the units comprising an ODF line, the substrate carrier 11 and/or the substrate buffer 12.

The third embodiment is more effective than the first and second embodiments in reducing inorganic ions and organic material, ensuring further reducing generation of spots, non-uniformity and bubbles in a liquid crystal display panel.

In the above-mentioned first and second embodiments, the present invention is applied to an ODF line. However, it should be noted that the present invention can be applied to various processes other than a process including steps of dropping liquid crystal onto one of substrates, and adhering the substrates to each other.

For instance, the present invention may be applied to a process including steps of adhering the array and CF substrates to each other with sealing material except an opening of the array or CF substrate through which liquid crystal is introduced into a gap formed between the array and CF substrates, introducing the array and CF substrates into a vacuum furnace to put the array and CF substrates in a reduced pressure, and introducing atmospheric pressure to the vacuum furnace with the opening being immerged in liquid crystal. Liquid crystal is introduced into a gap formed between the array and CF substrates in dependence on a difference in pressure. As an alternative, the present invention may be applied to a process including steps of adhering the array and CF substrates to each other with sealing material except both an inlet opening of the array or CF substrate through which liquid crystal is introduced into a gap formed between the array and CF substrates, and an exhaust opening, and absorbing liquid crystal into the gap with the inlet opening being immerged in liquid crystal by exhausting the gap through the exhaust opening.

In the above-mentioned first to third embodiments, the present invention is applied to a liquid crystal display panel. However, it should be noted that the present invention may be applied to a panel including a substrate accompanied with a problem of contaminants existing on a surface thereof. For instance, the present invention may be applied to an electroluminescence (EL) device, a field emission display (FED) device, a fluorescent display device, or a plasma display panel (PDP).

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2005-174977 filed on Jun. 15, 2005 including specification, claims, drawings and summary is incorporated herein by reference in its entirety.

What is claimed is:

1. An apparatus for fabricating a display panel including a pair of substrates facing each other, comprising:
units for carrying out steps for fabricating said display panel, said steps being to be carried out before said substrates are adhered to each other;
a substrate carrier for carrying said substrates;
a buffer for storing said substrates therein; and
at least one of a unit for substituting inert gas for internal gas, and a chemical filter unit, arranged in at least one of each of said units, said substrate carrier and said buffer.

2. The apparatus as set forth in claim 1, wherein said unit for substituting inert gas for internal gas is comprised of a unit for substituting nitrogen gas for internal gas.

3. The apparatus as set forth in claim 1, wherein said unit for substituting inert gas for internal gas maintains an oxygen concentration in said units, said substrate carrier and said buffer to be equal to or smaller than about 20%.

4. The apparatus as set forth in claim 1, wherein said display panel is comprised of a liquid crystal display panel.

5. The apparatus as set forth in claim 1, wherein said chemical filter unit removes organic materials which increase a contact angle of liquid crystal drops at surfaces of said substrates.

6. A method of fabricating a display panel including a pair of substrates facing each other, comprising:
(a) disposing at least one of a unit for substituting inert gas for internal gas and a chemical filter unit in areas where steps for fabricating said display panel are carried out before said substrates are adhered to each other; and
(b) measuring one of a contact angle of liquid crystal drops at surfaces of said substrates and a concentration of impurities residual at surfaces of said substrates to know cleanness of said surfaces of said substrates, based on the measured contact angle or concentration of impurities.

7. The method as set forth in claim 6, further comprising:
(c) rubbing said substrates;
(d) dropping liquid crystal onto one of said substrates; and
(e) adhering said substrates to each other with sealing material being sandwiched therebetween,
said (a) being carried out before and during said (c) and (d), said (b) being carried out prior to said (e).

8. The method as set forth in claim 6, wherein said inert gas is comprised of nitrogen gas.

9. The method as set forth in claim 6, wherein said unit for substituting inert gas for internal gas maintains an oxygen concentration in said areas to be equal to or smaller than about 20%.

10. The method as set forth in claim 6, wherein said chemical filter unit removes organic materials which increase a contact angle of liquid crystal drops at surfaces of said substrates.

11. The method as set forth in claim 6, wherein said contact angle is measured immediately before said substrates are adhered to each other.

12. The method as set forth in claim 11, wherein subsequent steps are carried out when said contact angle is equal to or smaller than about 13 degrees.

13. The method as set forth in claim 7, wherein said concentration of impurities is measured after said sealing material is drawn onto one of said substrates and further after spacers are distributed onto the other.

14. The method as set forth in claim 13, wherein subsequent steps are carried out when a total volume of cation and anion both existing at surfaces of said substrates is equal to or smaller than 1 ng/cm².

15. The method as set forth in claim 13, wherein subsequent steps are carried out when a total volume of organic material existing at surfaces of said substrates is equal to or smaller than 0.1 ng/cm².

16. The method as set forth in claim 6, wherein said display panel is comprised of a liquid crystal display panel.
